(19) United States
(12) Patent Application Publication
(10) Pub. No.: US 2024/0382981 A1
(43) Pub. Date: Nov. 21, 2024

(54) Nozzle Opening and Closing Device for Electrolyte Injection

(71) Applicant: Geon Guk Kim, Daejeon (KR)

(72) Inventor: Geon Guk Kim, Daejeon (KR)

(21) Appl. No.: 18/683,628

(22) PCT Filed: Feb. 22, 2023
(86) PCT No.: PCT/KR2023/002492

§ 371 Date: Feb. 14, 2024

(51) Int. Cl. B05B 1/32; B05B 12/08; H01M 50/609

(52) U.S. Cl. CPC B05B 1/323; B05B 12/081; H01M 50/609

(57) ABSTRACT

A nozzle opening and closing device for electrolyte injection comprises a nozzle having a discharge outlet for injecting an electrolyte into a battery assembly. The nozzle opening and closing device for electrolyte injection further comprises an opening and closing plate rotatably mounted on the nozzle, and provided to open or close the discharge outlet of the nozzle, and an opening and closing control part provided to control whether the opening and closing plate is opened or closed based on the weight of the electrolyte applied to the opening and closing plate.

### CROSS-REFERENCE TO RELATED APPLICATIONS

This application is a national phase entry under 35 U.S.C. § 371 of International Application No. PCT/KR2023/002492 filed Feb. 22, 2023, which claims priority to Korean Patent Application No. 20-2022-0000524 filed Feb. 25, 2022, the disclosures of which are incorporated herein by reference in their entirety.

### TECHNICAL FIELD

The present disclosure relates to a nozzle opening and closing device for electrolyte injection, which relates to a nozzle opening and closing device for electrolyte injection capable of preventing, in an electrolyte injection process, leakage of the electrolyte remaining in the nozzle upon moving of the injection nozzle or waiting for injection.

### BACKGROUND ART

As the supply of portable small electrical and electronic devices increases, development of new type secondary batteries such as nickel-metal hydride batteries and lithium secondary batteries is actively underway.

Lithium secondary batteries mean batteries using carbon, such as graphite, as a negative electrode active material, a lithium containing oxide as a positive electrode material, and a non-aqueous solvent as an electrolyte.

Such a secondary battery is manufactured in the form of a battery assembly by accommodating an electrode assembly, in which a positive electrode, a separator, and a negative electrode are sequentially measured, in an exterior material such as a pouch or a cylindrical can. Thereafter, a process of injecting the electrolyte into the battery assembly using an electrolyte injection device is performed.

In a conventional electrolyte injection process, the electrolyte is injected into the battery assembly using a nozzle.

At this instance, the nozzle for injecting the electrolyte into the battery assembly is formed in a simple cylindrical shape.

As the electrolyte injection nozzle is formed as a simple type cylindrical nozzle, the remaining electrolyte inside the electrolyte injection nozzle leaks out of the nozzle when the electrolyte injection nozzle moves and waits during the electrolyte injection process. Here, there is a problem in that the electrolyte leaking out of the nozzle falls on the equipment of the electrolyte injection process or the battery assembly. As such, there are problems in that the electrolyte injection process equipment is contaminated and corroded, and the pouch of the battery assembly is contaminated or the printing on the battery assembly is erased, by the electrolyte falling onto the electrolyte injection process equipment or the battery assembly.

In order to solve these problems, there is a need to develop a nozzle opening and closing device for electrolyte injection which can prevent residual electrolyte inside the nozzle for electrolyte injection from leaking out and facilitates opening and closing of the electrolyte injection nozzle.

### Technical Problem

It is an object of the present disclosure to provide a nozzle opening and closing device for electrolyte injection that can prevent, in an electrolyte injection process, leakage of residual electrolyte in the nozzle when the injection nozzle moves or waits for injection.

In addition, it is an object of the present disclosure to provide a nozzle opening and closing device for electrolyte injection that facilitates opening and closing of the electrolyte injection nozzle.

### Technical Solution

In order to solve the above-described problems, according to at least one embodiment of the present disclosure, a nozzle opening and closing device for electrolyte injection is provided, which comprises a nozzle having a discharge outlet for injecting an electrolyte into a battery assembly, an opening and closing plate rotatably mounted on the nozzle, and provided to open or close the discharge outlet of the nozzle, and an opening and closing control part provided to control whether the opening and closing plate is opened or closed based on the weight of the electrolyte applied to the opening and closing plate.

In addition, the opening and closing control part comprises a weight member provided so that rotational moment acts in the closing direction of the opening and closing plate, and the weight member is provided to be capable of adjusting a distance from the opening and closing plate.

### Advantageous Effects

As discussed above, the nozzle opening and closing device for electrolyte injection related to at least one embodiment of the present disclosure has the following effects.

It is possible to prevent residual electrolyte in the electrolyte injection nozzle from leaking out from the electrolyte injection nozzle when waiting for the electrolyte injection.

Also, during the electrolyte injection process, the electrolyte injection nozzle can be automatically opened due to the weight of the electrolyte.

In addition, as the electrolyte injection nozzle is automatically closed after completing the electrolyte injection, contamination of the electrolyte injection process equipment and contamination of the battery assembly due to leakage of the electrolyte can be prevented.

Furthermore, since the opening and closing of the electrolyte injection nozzle can be automatically controlled according to the weight of the electrolyte in the nozzle, the amount of the electrolyte injected into the battery assembly can be constantly adjusted.

### DESCRIPTION OF DRAWINGS

FIG. 1 is a front view of a nozzle opening and closing device for electrolyte injection according to one embodiment of the present disclosure.

FIG. 2 is a view for explaining the opening and closing plate, and the opening and closing control part shown in FIG. 1.

FIG. 3 is a side view of the opening and closing plate, and the opening and closing control part shown in FIG. 2.

FIG. 4 is a plan view of the opening and closing plate, and the opening and closing control part shown in FIG. 2.

FIG. 5 is a plan view of the fixing part shown in FIG. 1.

FIG. 6 is a view for explaining a use state of the opening and closing control part shown in FIG. 2.

FIG. 7 is a view showing an operating state of the nozzle opening and closing device for electrolyte injection shown in FIG. 1.

### DETAILED DESCRIPTION

Hereinafter, a nozzle opening and closing device for electrolyte injection according to one embodiment of the present disclosure (hereinafter, also referred to as an “opening and closing device”) will be described in detail with reference to the drawings.

In addition, regardless of the reference numerals, the same or corresponding components are given by the same or similar reference numerals, duplicate descriptions thereof will be omitted, and for convenience of explanation, the size and shape of each component member as shown can be exaggerated or reduced.

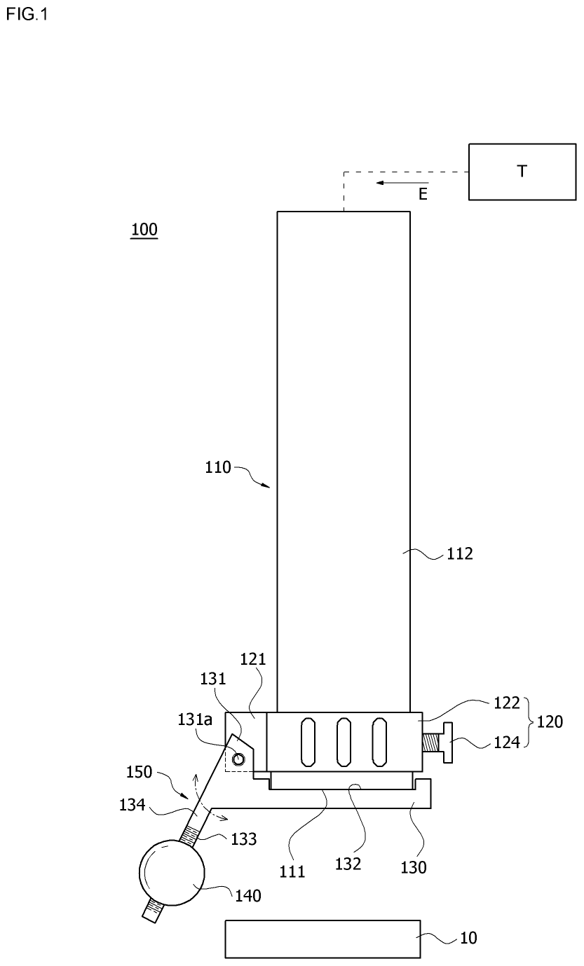

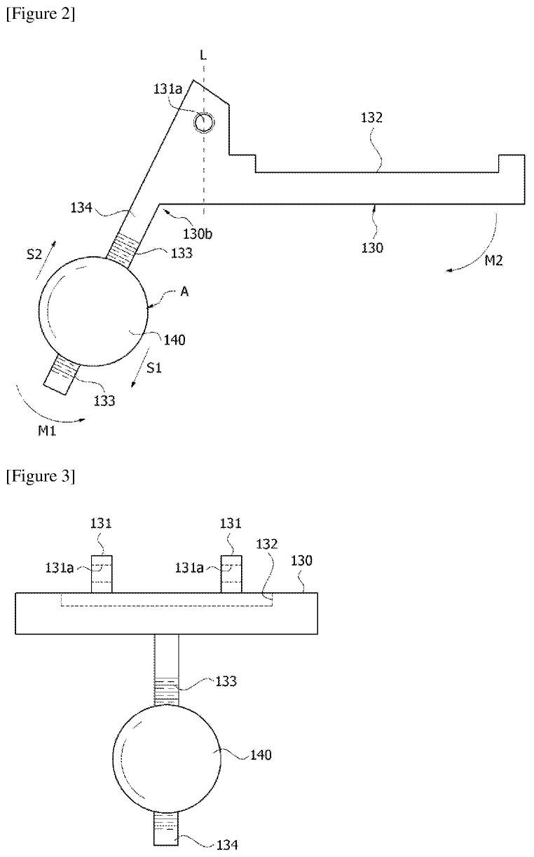

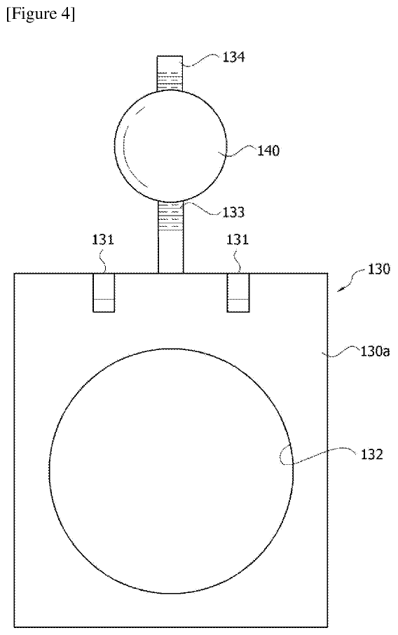

FIG. 1 is a front view of a nozzle opening and closing device for electrolyte injection according to one embodiment of the present disclosure, FIG. 2 is a view for explaining the opening and closing plate, and the opening and closing control part shown in FIG. 1, and FIG. 3 is a side view of the opening and closing plate, and the opening and closing control part shown in FIG. 2.

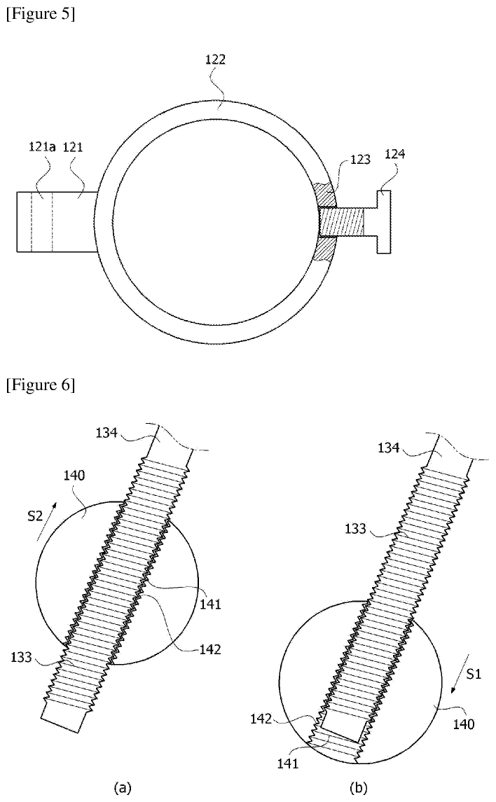

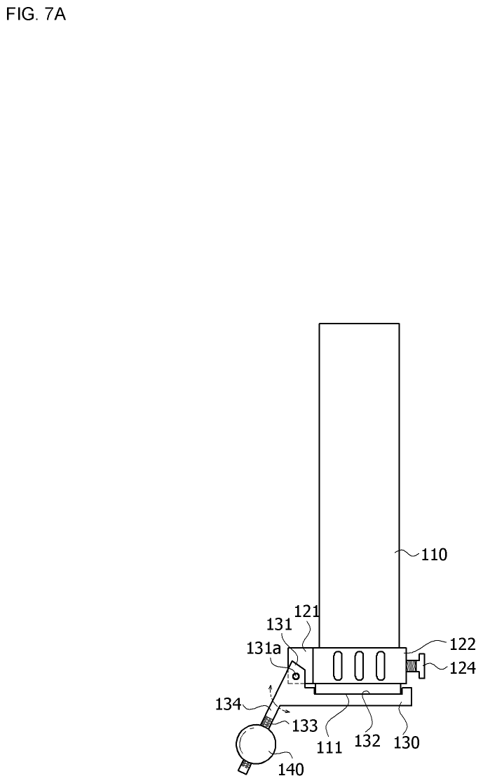

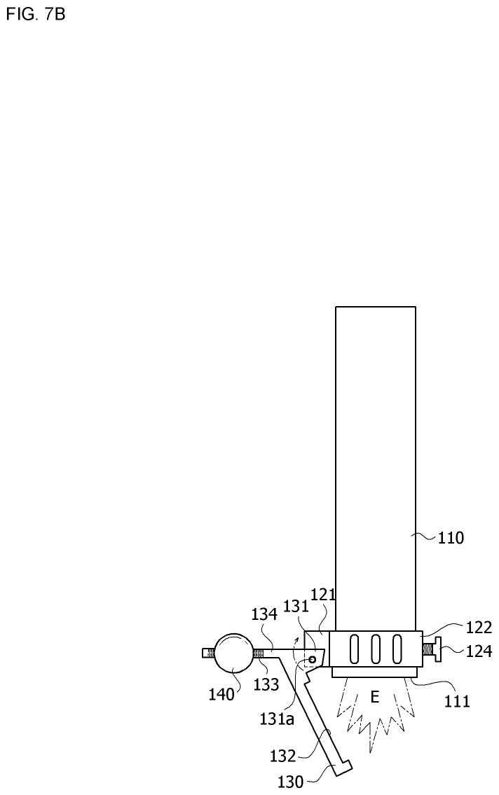

In addition, FIG. 4 is a plan view of the opening and closing plate, and the opening and closing control part shown in FIG. 2, FIG. 5 is a plan view of the fixing part shown in FIG. 1, FIG. 6 is a view for explaining a use state of the opening and closing control part shown in FIG. 2.

Referring to FIG. 1, the opening and closing device (100) according to one embodiment of the present disclosure comprises a nozzle (110), an opening and closing plate (130) and an opening and closing control part (150).

The opening and closing device (100) comprises a nozzle (110) having a discharge outlet (111) for receiving an electrolyte (E) and injecting the received electrolyte into a battery assembly (10), an opening and closing plate (130) rotatably mounted on the nozzle (110) and provided to open or close the discharge outlet (111) of the nozzle, and an opening and closing control part (150) provided to control whether the opening and closing plate (130) is opened or closed based on the weight of the electrolyte (E) applied to the opening and closing plate (130).

Also, the opening and closing control part (150) comprises a weight member (140) provided so that rotational moment acts in the closing direction (M1) of the opening and closing plate (130).

In addition, the weight member (140) is provided to be capable of adjusting a distance from the opening and closing plate (130).

Referring to FIG. 1, the nozzle (110) is a portion through which the electrolyte (E) injected into the battery assembly (10) is supplied.

In the nozzle (110), one end is connected to an electrolyte tank (T) to receive an electrolyte, and the received electrolyte is discharged to the outside of the nozzle (110) through the other end.

At this instance, the nozzle (110) has a discharge outlet (111) at the other end. The discharge outlet (111) of the nozzle (110) is closed by the opening and closing plate (130).

Referring to FIGS. 2 to 4, the opening and closing plate (130) is provided in the form of a plate, at least one surface of which is flat, to close the discharge outlet (111) of the nozzle (110).

The opening and closing plate (130) has a recessed portion (132) formed on one surface (130a) in contact with the discharge outlet (111) of the nozzle (110) when it is in a closed state.

In addition, the diameter of the recessed portion (132) may be formed to be larger than the diameter of the outer circumference surface (112) of the nozzle (110), and the diameter of the recessed portion (132) may be formed in a size more than or equal to the diameter of the outer circumference surface (112) of the nozzle (110).

When the discharge outlet (111) of the nozzle (110) is closed by the opening and closing plate (130), the discharge outlet (111) of the nozzle (110) is in contact with the recessed portion (132), which closes the discharge outlet (111) of the nozzle (110). When the electrolyte leaks from the discharge outlet (111) of the nozzle (110), the recessed portion (132) may perform a function of storing the leaked electrolyte in the space within the recessed portion, thereby preventing it from falling on the electrolyte injection process equipment (not shown) or the battery assembly (10).

Meanwhile, the opening and closing plate (130) is rotatably coupled to a position adjacent to the discharge outlet (111) of the nozzle (110).

The opening and closing plate (130) is provided to keep the discharge outlet (111) of the nozzle (110) in a closed state, or to rotate in one direction so that the discharge outlet (111) of the nozzle (110) is opened, according to the weight of the electrolyte supplied into the nozzle (110) to be applied.

The opening and closing device (100) may comprise a fixing part (120) mounted on the nozzle (110), and the fixing part (120) may have a rotating shaft on which the opening and closing plate (130) is rotatably mounted. As one example, the opening and closing plate (130) may be rotatably mounted on the rotating shaft through a pin.

The opening and closing plate (130) is mounted on the nozzle (110) through the fixing part (120).

Referring to FIGS. 1 and 5, the fixing part (120) is provided to be coupled to a position adjacent to the discharge outlet (111) of the nozzle (110), and to surround the outer circumference surface (112) of the nozzle (110).

The fixing part (120) may comprise a fixing member (122) provided to surround the outer circumference surface (112) of the nozzle (110) and a fixing means (124) fixing the fixing member (122) to the outer circumference surface (112) of the nozzle (110).

As one example, the fixing member (122) may be provided with a band or belt that may surround the nozzle (110). As one example, the fixing means (124) may be provided with a bolt having a tab (or thread).

Here, the fixing member (122) may have a fastening hole (123) into which the fixing means (124) is inserted, and the fixing means (124) may be fastened to the fastening hole (123) to contact the outer circumference surface (112) of the nozzle (110). Tabs (or threads) may be formed in the fastening hole (123) and the fixing means (124), respectively.

In such a structure, the fixing means (124) is fastened to the fastening hole (123) of the fixing member (122), whereby the fixing member (122) is fixed to the outer circumference surface (112) of the nozzle (110) by the fixing means (124).

Meanwhile, the opening and closing plate (130) is rotatably mounted on the fixing member (122).

That is, the fixing means (124) may be coupled to one region of the fixing member (122), and the opening and closing plate (130) may be coupled to another region of the fixing member (122). The fixing member (122) is provided with a first coupling piece (121) through which a first coupling hole (121a) is formed.

In addition, a second coupling piece (131) through which a second coupling hole (131a) is formed may be provided in the opening and closing plate (130). At this instance, the opening and closing plate (130) may be rotatably mounted to the fixing part (120) through a pin (not shown) passing through the second coupling hole (131a) and the first coupling hole (121a).

In a state where the discharge outlet (111) of the nozzle (110) is closed, the opening and closing plate (130) is provided to maintain the closed state, or to rotate in one direction so that the discharge outlet (111) of the nozzle (110) is opened, according to the weight of the electrolyte inside the nozzle (110).

The opening and closing control part (150) is provided to control whether the opening and closing plate (130) is opened or closed based on the weight of the electrolyte supplied to the nozzle (110) to be applied to the opening and closing plate (130).

The opening and closing control part (150) maintains the state where the discharge outlet (111) of the nozzle (110) is closed based on the weight of the electrolyte in the nozzle applied to the opening and closing plate, and to this end, it supports so that the opening and closing plate (130) does not rotate, or rotates the opening and closing plate (130) so that the discharge outlet (111) of the nozzle (110) is opened.

The opening and closing control part comprises a rod (134) and a weight member (140).

The opening and closing control part (150) is formed to extend from the end (130b) of the opening and closing plate (130) and comprises a rod (134) where the position of the weight member (140) is movably mounted.

At this instance, the opening and closing plate (130) and the rod (134) have the same rotation center, and when the weight of the electrolyte is applied to the opening and closing plate (130), the rotational moment acts to the opening and closing plate (130) in the opening direction (M2), and the rotational moment acts to the weight member (140) in the closing direction (M1) of the opening and closing plate (130).

Referring to FIGS. 2 and 6, when the weight member (140) on the rod (134) is moved in a direction (S1) away from the opening and closing plate (130), the rotational moment is increased in the closing direction (M1) of the opening and closing plate (130). Conversely, when the weight member (140) on the rod (134) is moved in a direction (S2) approaching the opening and closing plate (130), the rotational moment is reduced in the closing direction (M1) of the opening and closing plate (130).

The rod (134) may be formed to extend in different directions from the opening and closing plate (130) based on the rotation center. As one example, the rod (134) is formed to extend in a downside direction of the opening and closing plate (130) based on the state where the opening and closing plate is closed.

In the state where the opening and closing plate (130) is closed, the rod (134) and the opening and closing plate (130) may be located, based on a virtual line segment (L) passing through the rotation center and being orthogonal to the opening and closing plate, in the left and right regions of the line segment, respectively.

As one example, the rod (134) may be provided in the form of a stick having a predetermined length. Referring to FIG. 2, the rod (134) may be provided to be inclined at an oblique angle with respect to the opening and closing plate (130).

The weight member (140) is mounted at the end of the rod (134).

The weight member (140) has a weight corresponding to that of the opening and closing plate (130) to keep the state where the opening and closing plate (130) closes the discharge outlet (111) of the nozzle (110).

The weight member (140) is inserted into and coupled to the rod (134), and movably coupled along the longitudinal direction of the rod (134). When the distance between the weight member (140) and the opening and closing plate (130) is adjusted, the magnitude of the rotational moment generated in the closing direction (M1) of the opening and closing plate (130) changes, so that the distance of the weight member (140) may be pre-adjusted in consideration of the weight of the residual electrolyte.

For example, as shown in part (a) of FIG. 6, when the weight of the residual electrolyte that the opening and closing plate is set to be opened is low, the weight member (140) may be located close to the opening and closing plate (130). Conversely, as shown in part (b) of FIG. 6, when the weight of the residual electrolyte that the opening and closing plate is set to be opened is high, the weight member (140) may be located far from the opening and closing plate (130).

The weight member (140) may be provided so that the entire region is coupled to the rod (134), or a partial region is coupled thereto.

Referring to FIG. 6, a first tab (133) is formed on the outer circumference surface of the rod (134), and the weight member (140) is formed in a binding hole (142) into which the rod (134) is inserted and has a second tab (141) bound to the first tab (133). At this instance, the first tab (133) may be bound to the entire region or a partial region of the second tab (141).

The area (or length) of the first tab (133) may be larger than the area (or length) of the second tab (141).

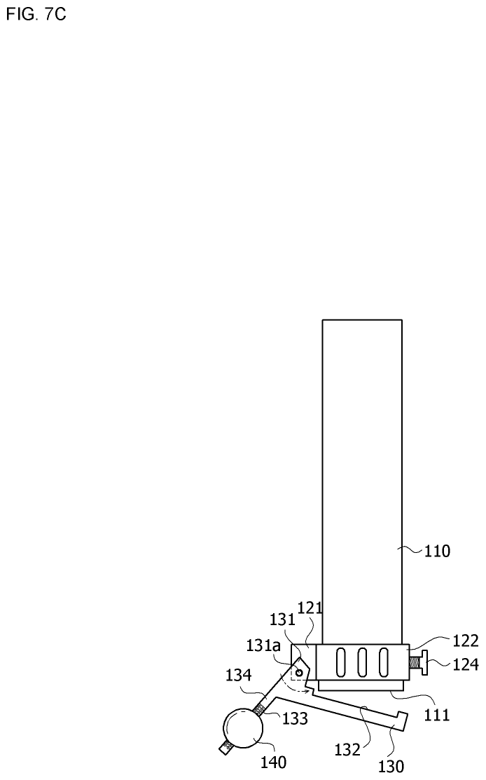

FIG. 7 is a view showing an operating state of the nozzle opening and closing device for electrolyte injection shown in FIG. 1.

Referring to FIG. 7, the electrolyte is supplied into the nozzle (110). The nozzle (110) is controlled by the opening and closing control part (150) where the opening and closing plate (130) is opened or closed based on the weight of the electrolyte supplied to the inside of the nozzle (110).

The rotational moment is generated in the closing direction (M1) of the opening and closing plate (130) by the weight member (140) based on the rotation center, and the rotational moment is generated in the opening direction (M2) of the opening and closing plate (130) by the weight of the electrolyte applied to the opening and closing plate (130). In such a structure, when the rotational moment generated in the closing direction (M1) is greater than the rotational moment generated in the opening direction (M2), the opening and closing plate may be maintained in the closed state. Conversely, when the rotational moment generated in the closing direction (M1) is smaller than the rotational moment generated in the opening direction (M2), the opening and closing plate is opened.

As described above, by adjusting the position of the weight member (140) on the rod (134), it is possible to adjust the magnitude of the rotational moment generated in the closing direction (M1). That is, by setting the position of the weight member (140) in advance in consideration of the weight of the residual electrolyte when the electrolyte is not injected, the opening and closing plate (130) may be set to be automatically closed.

As one example, referring to part (a) of FIG. 7, when the weight of the electrolyte applied to the opening and closing plate (130) through the nozzle (110) is lighter than the preset weight, it maintains a state where the discharge outlet (111) of the nozzle (110) is closed without being opened.

Referring to part (b) of FIG. 7, when the weight of the electrolyte applied to the opening and closing plate (130) through the nozzle (110) is greater than the preset weight, the discharge outlet (111) of the nozzle (110) is opened. At this instance, the electrolyte (E) is discharged from the nozzle (110) through the discharge outlet (111) of the nozzle (110). By the weight of the electrolyte (E) inside the nozzle (110), the opening and closing plate (130) rotates in one direction (opening direction) to open the discharge outlet (111) of the nozzle (110), and as a result, the electrolyte is discharged to the outside.

Referring to part (c) of FIG. 7, when the discharge of the electrolyte (E) inside the nozzle (110) is completed, the opening and closing plate (130) rotates to its original position to close the discharge outlet (111) of the nozzle (110).

Meanwhile, even when the discharge outlet (111) of the nozzle (110) is closed by the opening and closing plate (130), a small amount of residual electrolyte may remain inside the nozzle (110). At this instance, as shown in part (a) of FIG. 7, when the weight of the residual electrolyte applied to the opening and closing plate (130) through the nozzle (110) is lighter than the preset weight, it maintains the state where the discharge outlet (111) of the nozzle (110) is closed without being opened.

The preferred embodiments of the present disclosure as described above have been disclosed for illustrative purposes, and those skilled in the art having ordinary knowledge of the present disclosure will be able to make various modifications, changes, and additions within the spirit and scope of the present disclosure, and such modifications, changes, and additions should be regarded as falling within the scope of the following claims.

### INDUSTRIAL APPLICABILITY

According to the nozzle opening and closing device for electrolyte injection related to at least one embodiment of the present disclosure, it is possible to prevent the residual electrolyte in the electrolyte injection nozzle from leaking out from the electrolyte injection nozzle when waiting for the electrolyte injection.

1. A nozzle opening and closing device for electrolyte injection comprising:
a nozzle having a discharge outlet for receiving an electrolyte and injecting the received electrolyte into a battery assembly;
an opening and closing plate rotatably mounted on the nozzle and configured to open or close the discharge outlet of the nozzle; and
an opening and closing control part configured to control whether the opening and closing plate is opened or closed based on a weight of the electrolyte applied to the opening and closing plate, wherein:
the opening and closing control part includes a weight member provided so that a first rotational moment acts in a closing direction of the opening and closing plate, and
the weight member is configured to be capable of adjusting a distance from the opening and closing plate.

2. The nozzle opening and closing device for electrolyte injection according to claim 1, wherein:
the opening and closing control part is configured to extend from an end of the opening and closing plate, and comprises a rod where a position of the weight member is movably mounted,
the opening and closing plate and the rod have a same rotation center,
when the weight of the electrolyte is applied to the opening and closing plate, a second rotational moment acts to the opening and closing plate in an opening direction, and the first rotational moment acts to the weight member in the closing direction of the opening and closing plate.

3. The nozzle opening and closing device for electrolyte injection according to claim 2, wherein:
when the weight member on the rod is moved in a direction away from the opening and closing plate, the first rotational moment is increased in the closing direction of the opening and closing plate.

4. The nozzle opening and closing device for electrolyte injection according to claim 3, wherein:
when the weight member on the rod is moved in a direction approaching the opening and closing plate, the first rotational moment is reduced in the closing direction of the opening and closing plate.

5. The nozzle opening and closing device for electrolyte injection according to claim 2, wherein:
the rod is formed to extend in different directions from the opening and closing plate based on a rotation center.

6. The nozzle opening and closing device for electrolyte injection according to claim 2, wherein:
the weight member is provided so that an entire region is coupled to the rod.

7. The nozzle opening and closing device for electrolyte injection according to claim 6, wherein:
a first tab is formed on an outer circumference surface of the rod, and
the weight member is formed in a binding hole into which the rod is inserted, and has a second tab bound to the first tab.

8. The nozzle opening and closing device for electrolyte injection according to claim 7, wherein:
the first tab is bound to an entire region of the second tab.

9. The nozzle opening and closing device for electrolyte injection according to claim 2, further comprising:
a fixing part mounted on the nozzle, wherein:
the fixing part has a rotating shaft on which the opening and closing plate is rotatably mounted.

10. The nozzle opening and closing device for electrolyte injection according to claim 9, wherein:
the fixing part comprises a fixing member configured to surround an outer circumference surface of the nozzle; and
a fixing means configured to fix the fixing member to the outer circumference surface of the nozzle.

11. The nozzle opening and closing device for electrolyte injection according to claim 10, wherein:
the fixing member has a fastening hole into which the fixing means is inserted, and
the fixing means is fastened to the fastening hole to contact the outer circumference surface of the nozzle.

12. The nozzle opening and closing device for electrolyte injection according to claim 1, wherein:
the opening and closing plate has a recessed portion formed on one surface in contact with the discharge outlet of the nozzle when it is in a closed state.

13. The nozzle opening and closing device for electrolyte injection according to claim 12, wherein:
a diameter of the recessed portion is formed to be larger than the diameter of the outer circumference surface of the nozzle.

14. The nozzle opening and closing device for electrolyte injection according to claim 2, wherein:
the weight member is provided so that a partial region is coupled to the rod.

15. The nozzle opening and closing device for electrolyte injection according to claim 7, wherein:
the first tab is bound to a partial region of the second tab.
